(19) United States
(12) Patent Application Publication
(10) Pub. No.: US 2009/0128959 A1
(43) Pub. Date: May 21, 2009

(54) Self PSA adjustment using thermal adapter on suspension for improving takeoff in hot/wet environment

(75) Inventors: Shuyu Zhang, Fremont, CA (US); Zhong-Qing Gong, Fremont, CA (US)

Correspondence Address: IRELL & MANELLA LLP, 840 NEWPORT CENTER DRIVE, SUITE 400, NEWPORT BEACH, CA, 92660, US

(73) Assignee: Samsung Electronics Co., Ltd., Suwon City (KR)

(21) Appl. No.: 11/986,383

(22) Filed: Nov. 20, 2007

(51) Int. Cl. G11B 5/60; G11B 21/20

(52) U.S. Cl. 360/235.4

(57) ABSTRACT

A suspension arm assembly for a hard disk drive that includes a suspension arm and a thermal adaptor. The thermal adaptor has a thermal coefficient of expansion that is different from the thermal coefficient of expansion of the suspension arm so that a pitch static angle is increased with an increase in temperature. The suspension arm assembly is attached to an actuator arm and coupled to a head of the disk drive. The head may be parked on a landing zone of a disk surface while the disk is stationary. When the disk is spun, an air bearing is formed between the disk surface and the head. If the drive is operating at an elevated temperature the static angle of the suspension arm will increase to increase the slider's pitch angle and air bearing flying height.

### BACKGROUND OF THE INVENTION

1. Field of the Invention

The present invention relates to a suspension arm assembly of a hard disk drive.

2. Background Information

Hard disk drives contain a plurality of magnetic heads that are coupled to rotating disks. The heads can magnetize and sense the magnetic fields of the disks to write and read data, respectively. The heads are coupled to a pivoting actuator arm that has a voice coil motor. The disks are rotated by a spindle motor of the drive.

Data is typically stored on tracks that extend radially across the disk surfaces. The voice coil motor can be energized to pivot the actuator arm and move the heads to different track locations. Each track is typically divided into a number of sectors. Each sector contains at least one data field. Data is typically written onto a number of sectors during a write operation of the drive.

Each head has an air bearing surface. The rotating disks generate a flow of air that cooperates with the air bearing surface to create an air bearing between a head and the adjacent disk surface. The air bearing eliminates or minimizes mechanical contact between the head and the disk.

The disks are magnetized and data is written with a magnetic field that emanates from the heads. The magnetic field is created by providing a current to a coil that is embedded into the head. Magnetization of the disks is a function of the height of the air bearing. A taller air bearing will produce a weaker magnetic field and vice versa.

The height of each air bearing is a function of the air within the drive. The air is a function of temperature and altitude. For example, the air bearing will become smaller with an increase in temperature.

When a disk drive is not in operation the heads are typically parked on either a ramp or a non-data landing zone of a disk surface. The former technique is called Load/Unload (LUL) and the latter is called Contact Start Stop (CSS). Power to the disk may also be terminated. When the drive again becomes operational, the disk is spun and the heads are moved from the landing zone after reaching an acceptable fly height. For CSS drives, a slider's minimum flying height (FH) is usually located at the carbon pads. The minimum flying height is significantly affected by pitch angle because the carbon pads are higher than air bearing surface (ABS) during takeoff and landing. At elevated temperatures and humidity, slider's pitch angle will be reduced, which consequently will reduce its minimum FH and the head will tend to drag along the disk surface during “take-off” until it reaches an acceptable fly height. This increases the take-off time and reduces the access time of the disk drive. Adjustments may be made in the slider design, etc. but this would affect the normal fly height of the head.

### BRIEF SUMMARY OF THE INVENTION

A suspension arm assembly for a hard disk drive that includes a suspension arm and a thermal adaptor. The thermal adaptor has a thermal coefficient of expansion that is different from the thermal coefficient of expansion of the suspension arm so that a slider pitch static angle is increased with an increase in temperature.

### BRIEF DESCRIPTION OF THE DRAWINGS

FIG. 1 is a top view of an embodiment of a hard disk drive;

FIG. 2 is a top view of a suspension arm assembly;

FIG. 3 is a side view of the suspension arm assembly;

FIG. 4 is a schematic of an electrical circuit for the hard disk drive.

### DETAILED DESCRIPTION

Disclosed is a suspension arm assembly for a hard disk drive that includes a suspension arm and a thermal adaptor. The thermal adaptor has a thermal coefficient of expansion that is different from the thermal coefficient of expansion of the suspension arm so that a pitch static angle is increased with an increase in temperature. The suspension arm assembly is attached to an actuator arm and coupled to a head of the disk drive. The head may be parked on a landing zone of a disk surface for CSS drives while the disk is stationary. When the disk is spun, an air bearing is formed between the disk surface and the head. If the drive is operating at an elevated temperature the pitch static angle (“PSA”) of the suspension arm assembly will increase to assist in pulling the head away from the disk surface. The increased PSA adds additional pitch torque on the slider. The additional pitch torque assists in increasing the slider pitch angle and minimum FH during takeoff. This reduces the take-off time and corresponding access time of the drive.

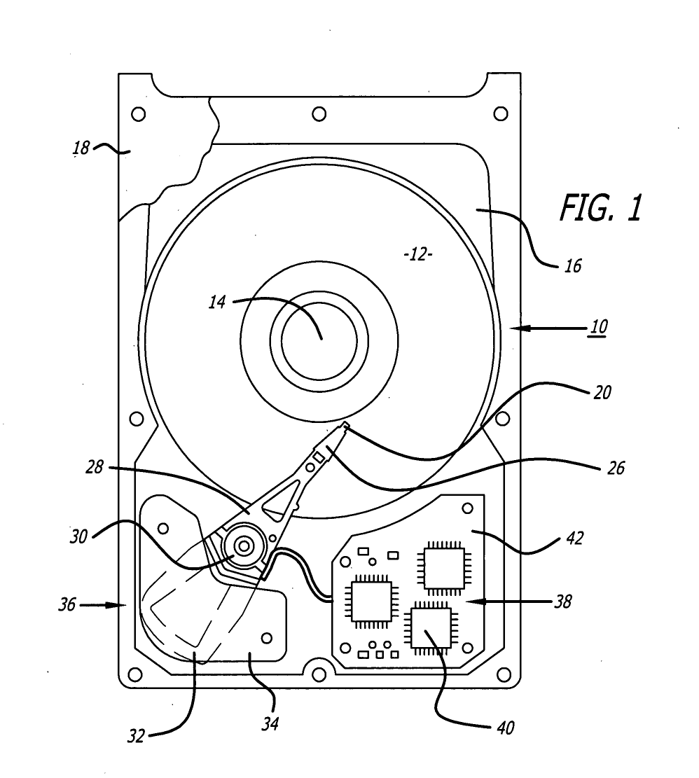

Referring to the drawings more particularly by reference numbers, FIG. 1 shows an embodiment of a hard disk drive 10 of the present invention. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. Each head 20 may have separate write (not shown) and read elements (not shown). The heads 20 are gimbal mounted to a suspension arm assembly 26 as part of a head gimbal assembly (HGA). The flexure arms 26 are attached to an actuator arm 28 that is pivotally mounted to the base plate 16 by a bearing assembly 30. A voice coil 32 is attached to the actuator arm 28. The voice coil 32 is coupled to a magnet assembly 34 to create a voice coil motor (VCM) 36. Providing a current to the voice coil 32 will create a torque that swings the actuator arm 28 and moves the heads 20 across the disks 12.

The hard disk drive 10 may include a printed circuit board assembly 38 that includes a plurality of integrated circuits 40 coupled to a printed circuit board 42. The printed circuit board 42 is coupled to the voice coil 32, heads 20 and spindle motor 14 by wires (not shown).

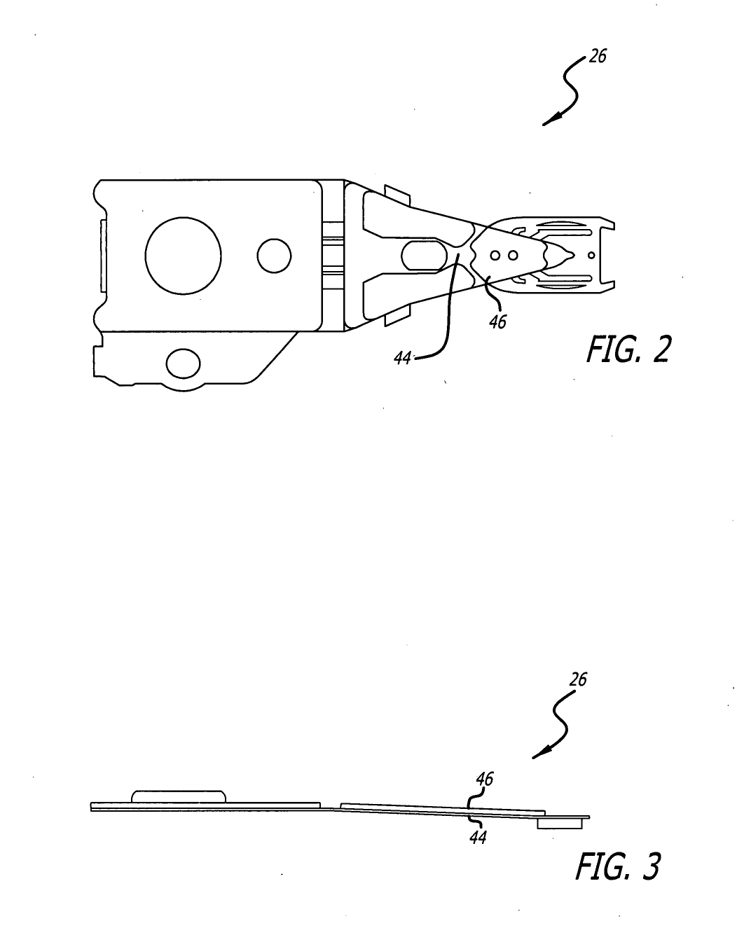

FIGS. 2 and 3 show an embodiment of the suspension arm assembly 26. The assembly 26 includes a suspension arm 44. A thermal adaptor 46 is attached to the suspension arm 44. The suspension arm 44 is typically constructed from a steel material which has a thermal coefficient of expansion (“TCE”). The thermal adaptor 46 has a thermal coefficient of expansion, that is different from the TCE of the suspension arm 44, so that a pitch static angle of the entire suspension arm assembly 26 will increase with an increase in temperature. For example, the thermal adaptor 46 may have a TEC that is more than the TCE of the suspension arm. The adaptor will expand more and pull the suspension arm away from the disk surface.

By way of example, the thermal adaptor 46 may be constructed as a zinc plate having a thickness of 0.11 millimeters. Such a plate can create an increase in the pitch static angle of 1.7 degrees with an increase in temperature of 60° C. Simulations have shown that an increase in pitch static angle of 1.5° can decrease the take-off time of the head by 20% for drives operating in a hot/wet environment.

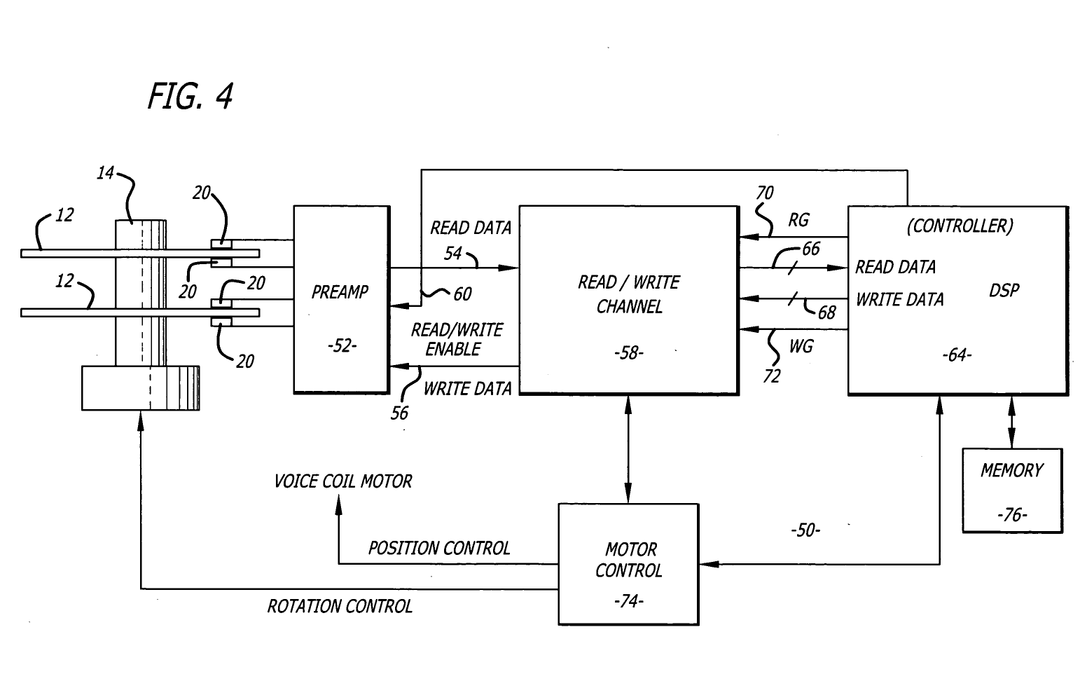

FIG. 4 shows an electrical circuit 50 for reading and writing data onto the disks 12. The circuit 50 may include a pre-amplifier circuit 52 that is coupled to the heads 20. The pre-amplifier circuit 52 has a read data channel 54 and a write data channel 56 that are connected to a read/write channel circuit 58. The pre-amplifier 52 also has a read/write enable gate 60 connected to a controller 64. Data can be written onto the disks 12, or read from the disks 12 by enabling the read/write enable gate 60.

The read/write channel circuit 58 is connected to a controller 64 through read and write channels 66 and 68, respectively, and read and write gates 70 and 72, respectively. The read gate 70 is enabled when data is to be read from the disks 12. The write gate 72 is to be enabled when writing data to the disks 12. The controller 64 may be a digital signal processor that operates in accordance with a firmware and/or software routine, including a routine(s) to write and read data from the disks 12. The read/write channel circuit 58 and controller 64 may also be connected to a motor control circuit 74 which controls the voice coil motor 36 and spindle motor 14 of the disk drive 10. The controller 64 may be connected to a non-volatile memory device 76. By way of example, the device 76 may be a read only memory (“ROM”).

The controller 64 can operate the drive so that during a power down mode the heads are parked on a landing zone of a disk surface. The disk may be spun down to further conserver power. To resume operation, the disk is spun up to lift the heads off of the disk surfaces. At elevated temperatures and humidity the slider's minimum fly height is normally reduced so that it takes a longer time for the heads to take-off. The thermal adaptor increases the slider's pitch angle and minimum flying height to assist in the lift of the head to reduce take-off time and access time of the drive.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A suspension arm assembly for a hard disk drive, comprising:
a suspension arm that has a thermal coefficient of expansion; and,
a thermal adaptor attached to said suspension arm, said thermal adaptor having a thermal coefficient of expansion different from said thermal coefficient of expansion of said suspension arm so that a pitch static angle is increased with an increase in temperature.

2. The assembly of claim 1, wherein said suspension arm is constructed from a steel material and said thermal adaptor is constructed from a zinc material.

3. The assembly of claim 2, wherein said thermal adaptor has a thickness of 0.1 mm.

4. The assembly of claim 1, wherein said pitch static angle varies as a function of temperature by approximately 1.7/60 degrees per degrees Celsius.

5. A hard disk drive, comprising:
a housing;
a disk;
a spindle motor that is mounted to said housing and rotates said disk;
an actuator arm;
a voice coil motor coupled to said actuator arm;
a suspension arm assembly coupled to said actuator arm, said suspension arm assembly including;
a suspension arm that has a thermal coefficient of expansion;
a thermal adaptor attached to said suspension arm, said thermal adaptor having a thermal coefficient of expansion different from said thermal coefficient of thermal expansion of said suspension arm so that a pitch static angle is increased with an increase in temperature; and,
a head coupled to said suspension arm assembly.

6. The disk drive of claim 5, wherein said suspension arm is constructed from a steel material and said thermal adaptor is constructed from a zinc material.

7. The disk drive of claim 6, wherein said thermal adaptor has a thickness of 0.1 mm.

8. The disk drive of claim 5, wherein said pitch static angle varies as a function of temperature by approximately 1.7/60 degrees per degrees Celsius.

9. A method for lifting a head from a disk of a hard disk drive, comprising:
providing a disk drive that includes;
a disk;
a spindle motor that is mounted to said housing and rotates said disk;
an actuator arm;
a voice coil motor coupled to said actuator arm;
a suspension arm assembly coupled to said actuator arm, said suspension arm assembly including;
a suspension arm that has a thermal coefficient of expansion;
a thermal adaptor attached to said suspension arm, said thermal adaptor having a thermal coefficient of expansion different from said thermal coefficient of expansion of said suspension arm so that a pitch static angle is increased with an increase in temperature;
rotating the disk when the disk drive is operating at an elevated temperature, the suspension arm assembly increases the pitch static angle under the elevated temperature; and,
moving the head away from a landing zone of the disk.

10. The method of claim 9, wherein the pitch static angle varies as a function of temperature by approximately 1.7/60 degrees per degrees Celsius.
